(19) United States
(12) Patent Application Publication
(10) Pub. No.: US 2011/0310276 A1
(43) Pub. Date: Dec. 22, 2011

(54) OPTICAL APPARATUS AND IMAGING APPARATUS USING THE SAME

(76) Inventors: Jae-Guyn Lim, Seongnam-si (KR); Byung-Kwan Park, Seoul (KR); Won-Hee Choe, Hwaseong-si (KR); Seong-Deok Lee, Seongnam-si (KR)

(21) Appl. No.: 13/114,265

(22) Filed: May 24, 2011

(30) Foreign Application Priority Data
Jun. 17, 2010 (KR) 10-2010-0057770

(51) Int. Cl. H04N 5/335

(52) U.S. Cl. 348/273; 348/E05.091

(57) ABSTRACT

An optical apparatus and an imaging apparatus capable of facilitating capturing images with a simpler structure are provided. The imaging apparatus includes a color filter divided into a plurality of regions, each of the regions configured to allow light of a preset wavelength range to pass therethrough, a main lens disposed at a front or a rear of the color filter to allow light to pass therethrough, and an optic unit to allow the light passing through the color filter or the main lens to pass therethrough.

### CROSS-REFERENCE TO RELATED APPLICATION

This application claims the benefit under 35 U.S.C. §119(a) of Korean Patent Application No. 10-2010-0057770, filed on Jun. 17, 2010, the entire disclosure of which is incorporated herein by reference for all purposes.

### BACKGROUND

1. Field

The following description relates to an optical apparatus for acquiring an image, and an imaging apparatus using the same.

2. Description of the Related Art

Conventional imaging apparatuses exhibit perform poorly when attempting to capture a high quality image in certain image capturing environments, such as a low light condition. In order to capture a high quality image in such an environment as the aforementioned low light condition, an image sensor needs to absorb light of a long wavelength range. However, the image sensor of a conventional imaging apparatus typically only absorbs light of a short wavelength range corresponding to colors of red, green, and blue, or cyan, magenta, and yellow.

Accordingly, many studies have been undertaken to implement an algorithm and structure of an image sensor that can absorb light of a wavelength longer than that of red, green, and blue, or cyan, magenta and yellow.

### SUMMARY

In one general aspect, there is provided an imaging apparatus including a color filter, a main lens, and an optic unit. The color filter is divided into a plurality of regions, each of the regions configured to allow light of a preset wavelength range to pass therethrough. The main lens is disposed at a front or a rear of the color filter to allow light to pass therethrough. The optic unit allows the light passing through the color filter or the main lens to pass therethrough.

The optic unit may be configured to change an angle of transmission of the light passing through the optic unit.

The imaging apparatus may further include an image sensor to receive the light, and a number of the regions of the color filter may be equal to or less than a number of pixels of the image sensor that are used to recognize a single point.

The angle of transmission of the light passing through the optic unit and a number of pixels of the image sensor used to recognize a single point corresponds to a position and/or shape of the optic unit.

The main lens may be divided into regions corresponding to the regions of the color filter.

The optic unit may be formed using a micro-lens array and/or a heterodyne mask.

The imaging apparatus may further include an infrared ray cut off filter configured to block infrared rays.

The imaging apparatus may include an image sensor to recognize light passing through the optic unit.

In another general aspect, there is provided an optical apparatus including a color filter and a main lens. The color filter is divided into a plurality of regions, each of the regions configured to allow light of a preset wavelength range to pass therethrough. The main lens is disposed at a front or a rear of the color filter to allow light to pass light therethrough.

The main lens may be divided into regions corresponding to the regions of the color filter.

The optical apparatus may further include an infrared ray cut off filter which is disposed at a front or a rear of the main lens to block infrared rays.

In another general aspect, there is provided an imaging apparatus including a color filter having a plurality of regions, wherein at least two of the regions transmit light of different wavelengths, and a number of the regions is equal to or less than a number of pixels of an image sensor receiving the light.

The imaging apparatus may further include a main lens provided at a front or rear of the color filter.

The color filter may be integrated with the main lens.

The color filter may be formed on the main lens with a color resin.

The color filter may be a dichroic filter.

The main lens may have a plurality of regions corresponding to the regions of the color filter.

The imaging apparatus may further include an optic unit to change an angle of transmission of the light, and the image sensor to receive the light from the optic unit.

A number of pixels of the image sensor used to recognize a portion of an object may correspond to a position and/or shape of the optic unit.

The imaging apparatus may further include an infrared ray cut off filter to block infrared rays.

Other features and aspects may be apparent from the following detailed description, the drawings, and the claims.

### BRIEF DESCRIPTION OF THE DRAWINGS

FIG. 1 illustrates an example of an imaging apparatus.

FIG. 2 illustrates example shapes of separate regions of a color filter of the imaging apparatus.

FIG. 3 illustrates another example of an imaging apparatus.

FIG. 4 is a graph illustrating a spectral sensitivity.

FIGS. 5A and 5B illustrate examples of an optic unit.

FIGS. 6A and 6B illustrate the change in number of pixel regions used to recognize a single point.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

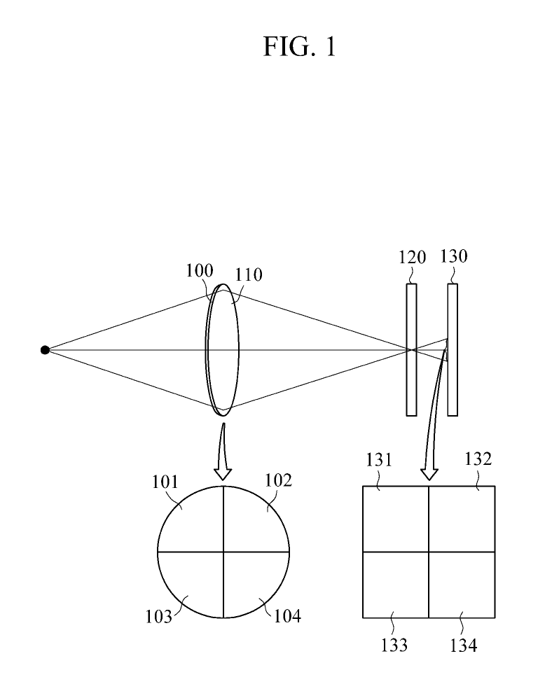

FIG. 1 illustrates an example of an imaging apparatus.

The example imaging apparatus illustrated in FIG. 1 includes a color filter 100, a main lens 110, an optic unit 120, and an image sensor 130.

FIG. 1 also illustrates an optical path made in an example in which the imaging apparatus recognizes a predetermined point of an object to be photographed. The description of the optical path has been made in relation to the predetermined point for the purposes of the discussion of this example, but may be applicable to any other points associated with the object.

If a point recognized by the imaging apparatus is disposed above the predetermined point illustrated in FIG. 1, the optical path from such a point deflects downward and light is incident to a lower portion of the main lens 110, and is transmitted through the optic unit 120 so as to be incident to an upper portion of the image sensor 130. If a point recognized by the imaging apparatus is disposed below the predetermined point illustrated in FIG. 1, the optical path from such a point deflects upward and light is incident to an upper portion of the main lens 110, and is transmitted through the optic unit 120 so as to be incident to a lower portion of the image sensor 130. In this manner, light rays corresponding to respective points of the object are incident to the image sensor 130 by sequentiallly passing through the color filter 100, the main lens 110, and the optic unit 120. The image sensor 130 captures an image of the object based on the light rays that have passed through these components of the imaging apparatus.

As illustrated in FIG. 1, the color filter 100 is divided into a plurality of regions. Each of the divided regions of the color filter 100 allows light of a preset wavelength range to pass therethrough. More particularly, the divided regions of the color filter 100 may allow light of different wavelength ranges to pass therethrough, respectively. For example, if the color filter 100 is divided into four regions, respective divided regions 101, 102, 103, and 104 may allow light of wavelength ranges corresponding to the colors red (R), green (G), blue (B) and G to pass therethrough, respectively. For example, the first region 101 may allow light of a red wavelength range to pass therethrough, the second region 102 may allow light of a green wavelength range to pass therethrough, the third region 103 may allow light of a blue wavelength range to pass therethrough, and the fourth region 104 may allow light of a green wavelength range to pass therethrough.

In another example, the divided regions 101, 102, 103, and 104 may be configured to allow light of wavelength ranges corresponding to the colors cyan (C), yellow (Y), yellow (Y), and magenta (M) to pass therethrough, respectively. In yet another example, the divided regions 101, 102, 103, and 104 may be configured to allow light of wavelength ranges corresponding to the colors C, M, Y, and black (K) to pass therethrough, respectively. The divided regions may be configured to allow light of various combinations of color patterns to pass therethrough. The description of the color filter has been made in relation to having four divided regions, but the color filter may be divided in various numbers and configurations, such as, for example, 16 (4×4) and 64 (8×8).

In one example, the color filter 100 may be implemented using color resin. In another example, the color filter 100 may be a dichroic filter. In other various examples, the color filter 100 may be implemented in various forms.

As illustrated in the example of FIG. 1, the color filter 100 is disposed in front of the main lens 110 relative to the object to be photographed, but the disposition of the color filter 100 is not limited thereto. In another example, the color filter 100 may be disposed at a rear side of the main lens 110. The color filter 100 may be implemented as a separate unit disposed in front of or behind the main lens 110. In another example, the color filter 100 may be implemented as being coated on a front surface or a rear surface of the main lens 110. In other words, in various examples the color filter 100 may be provided as a separate unit from the main lens 110, or may be provided integrally with the main lens 110.

The main lens 110 may be disposed in front of or behind the color filter 100, relative to the object to be photographed. The main lens 110 may be divided into regions to correspond to the divided regions of the color filter 100. For example, the regions of the main lens 110 may correspond to the regions 101, 102, 103, and 104 of the color filter 100, respectively. That is, in this example, the divided regions of main lens 110 may match the divided regions 101, 102, 103, and 104 of the color filter 100 in one-to-one correspondence.

For example, if the color filter 100 is divided into four regions, the main lens 110 may be divided into four regions. The shapes of the divided regions of the main lens 110 may correspond to the divided regions of the color filter 100. For example, if each divided region of the color filter 100 has a circular shape, the divided region of the main lens 110 may also be provided in a circular shape. The divided regions of the main lens 110, although not illustrated in the drawing, may each have a shape similar to the shape of the divided regions of the color filter 100.

The main lens 110 allows light to pass therethrough. Light passing through the main lens 110 passes by a focal point of the main lens 110. For example, if the color filter 100 is disposed in front of the main lens 110, light that has been incident to the color filter 100 passes through the main lens 110. If the color filter 100 is disposed at a rear side of the main lens 110, light incident from outside passes through the main lens 110 and then is introduced into the color filer 100.

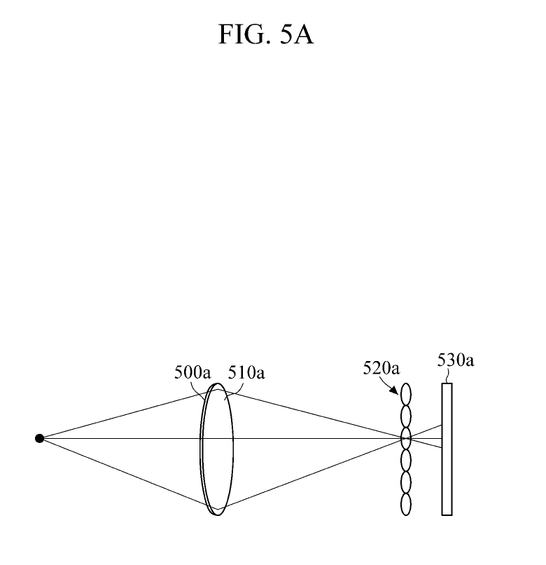

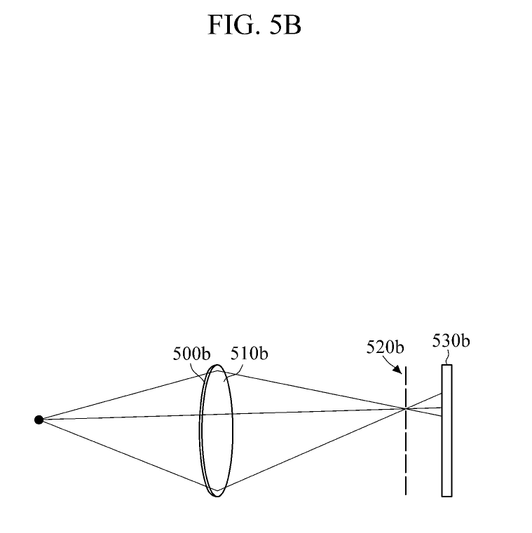

The optic unit 120 may change an angle of transmission of light, which has passed through the color filter 100 and the main lens 110, while the light is passing through the optic unit 120. The optic unit 120 may be implemented, for example, using a micro-lens array including a plurality of microlenses, or using a heterodyne mask, and so on. The configuration of the optic unit 120 will be described in more detail with reference to FIGS. 5A and 5B.

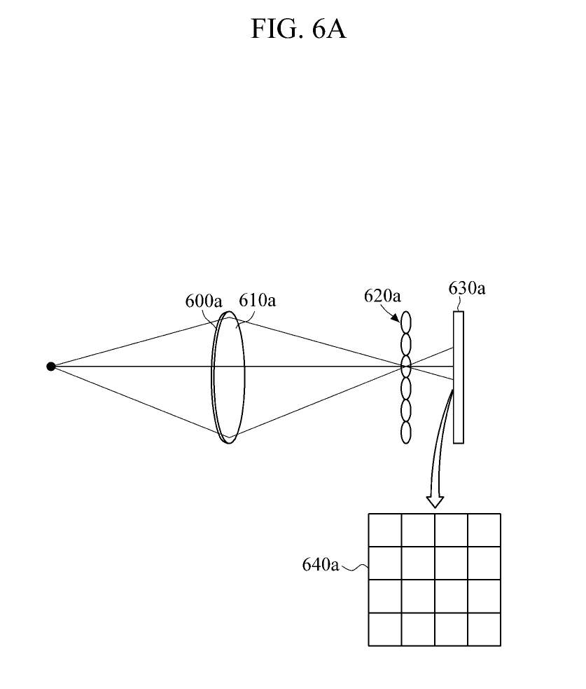

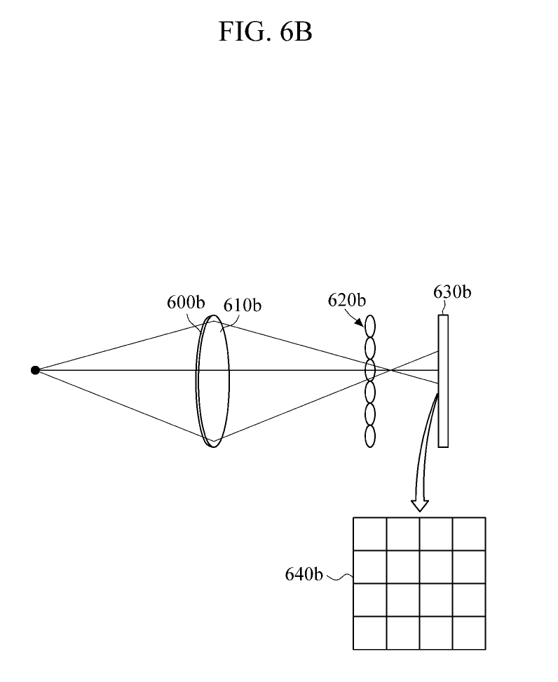

If the position or shape of the optic unit 120 is changed, the angle of transmission of the light passing through the optic unit 120 is changed. The change of the angle of transmission of light will be described in more detail with reference to FIGS. 6A and 6B.

The optic unit 120 allows light passing through the color filter 100 and the main lens 110 to travel with a changed angle, thereby changing an area of a portion of the image sensor 130 receiving the light. That is, with the change of angle of transmission, the number of pixels of the image sensor 130 used to recognize the light is changed. For example, if the optic unit 120 changes the angle of transmission of light, the number of pixels of the image sensor 130 used to recognize the light may be increased from 4(2×2) to 16(4×4). A more detailed description of the number of pixels of the image sensor with the change of an angle of light will be made with reference to FIGS. 6A and 6B.

The image sensor 130 recognizes light passing through the optic unit 120. In this case, the image sensor 130 may include a plurality of photosensors. A photosensor may be provided for each pixel, so the image sensor 130 recognizes incident light in units of pixels. Accordingly, the image sensor 130 captures an image based on the incident light in units of pixels.

The image sensor 130 may use 2×2 pixels including a first pixel 131, a second pixel 132, a third pixel 133, and a fourth pixel 134 to recognize a single point of an object. For example, the color filter 100 may be divided into the previously described four regions 101, 102, 103, and 104, and the image sensor 130 may use the 2×2 pixels 131, 132, 133, and 134 to recognize a single point of an object. In this example, light passing through the first region 101 is incident to the first pixel 131, light passing through the second region 102 is incident to the second pixel 132, light passing through the third region 103 is incident to the third pixel 133, and light passing through the fourth region 104 is incident to the fourth pixel 134.

According to various examples, the number of divided regions of the color filter 100 or the main lens 110 may be equal to or less than the number of pixels of the image sensor 130 used to recognize a single point of an object. As described above, the number of pixels of the image sensor 130 used to recognize a single point of an object may be changed by the position or the shape of the optic unit 120.

A control unit (not illustrated) may be provided to the imaging apparatus, and may recognize an angle of light based on a relative position of a pixel to which the light is incident. The control unit may be integrated with the imaging apparatus, or may be provided separately.

For example, it may be assumed that the first region 101 of the color filter 100 allows light of a red wavelength range to pass therethrough, the second region 102 of the color filter 100 allows light of a green wavelength range to pass therethrough, the third region 103 of the color filter 100 allows light of a blue wavelength range to pass therethrough, the fourth region 104 of the color filter 100 allows light of a green wavelength range to pass therethrough. The image sensor 130 may use the first pixel 131, the second pixel 132, the third pixel 133, and the fourth pixel 134 to recognize a single point in an object. The control unit may recognize that the first pixel 131 corresponds to the fourth region 104 of the color filter 100, the second pixel 132 corresponds to the third region 103 of the color filter 100, the third pixel 133 corresponds to the second region 102 of the color filter 100, and the fourth pixel 134 corresponds to the first region 101 of the color filter 100. In this case, the control unit may calculate the angle of light incident onto the first pixel 131 based on a line connecting between the fourth region 104 and the first pixel 131, in which the angle is a 2-dimensional value.

In a similar manner, the control unit may calculate the angles of light incident onto the remaining pixels 132, 133, and 134, and may recognize the wavelength range of incident light.

In this example, the color filter 100 and the main lens 110 may implement an optical apparatus in cooperation with each other.

That is, the optical apparatus may include a color filter 100 and a main lens 110. The color filter 100 may be divided into a plurality of regions, each region allowing light of a preset wavelength range to pass therethrough. The main lens 110 may be disposed in front of or behind the color filter 100 and allows light to pass therethough. The main lens 110 may be divided into regions corresponding to the divided regions of the color filter 100, and allows light to pass through the divided regions.

The structure of the color filter 100 may be simplified in the imaging apparatus by placing the color filter 100 in front of or behind the main lens 110. In a conventional imaging apparatus, a general color filter may be disposed inside an image sensor and formed to correspond to units of pixels of the image sensor, causing implementation complexity. However, the various examples in which the color filter 100 is disposed in front of or behind the main lens 110, as thus far described in regard to FIG. 1, thereby simplifies the implementation.

In addition, the various examples of the imaging apparatus thus far described, which have the color filter 100 disposed in front of or behind the main lens 110, and which may remove the color filter 100 from the image sensor, may simplify the physical structure of the image sensor 130.

In addition, the various examples of the color filter 100 thus far described, which have the color filter 100 disposed in front of or behind the main lens 110, may recognize light of multi-wavelength ranges without additional processing performed by the image sensor.

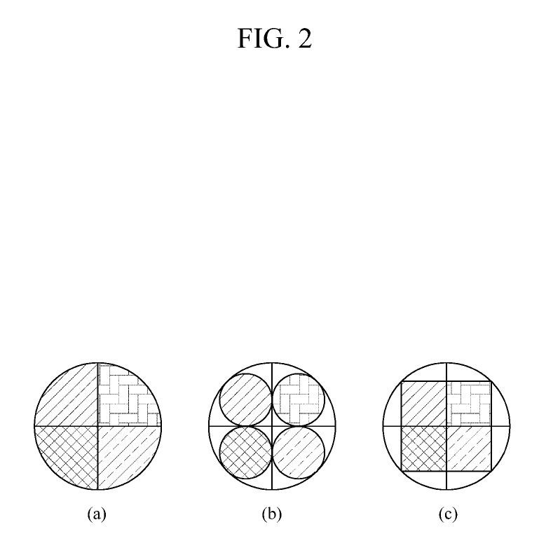

FIG. 2 illustrates example shapes of separate regions of a color filter of the imaging apparatus.

As illustrated in FIG. 2, the shape and the size of the divided regions of the color filter may be implemented in various forms. For example, the color filter may have an arc shape and a size illustrated in FIG. 2(a), a circular shape and a size illustrated in FIG. 2(b), and a rectangular shape and a size illustrated in FIG. 2(c). These shapes and sizes of the divided regions are merely examples, and it is understood that the shape and size of the separate regions of the color filter are not limited thereto.

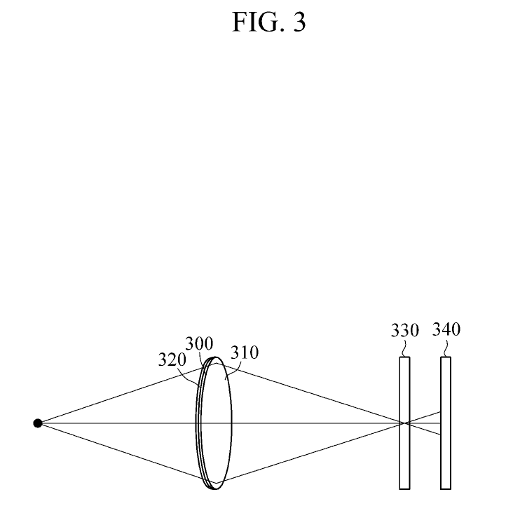

FIG. 3 illustrates another example of an imaging apparatus.

As illustrated in FIG. 3, another example of the imaging apparatus includes a color filter 300, a main lens 310, an infrared cut-off filter 320, an optic unit 330, and an image sensor 340.

The color filter 300 may be divided into a plurality of regions, each region configured to allow light of a preset wavelength range to pass therethrough. The divided regions of the color filter allow light of different wavelength ranges to pass therethrough, respectively.

The main lens 310 may be disposed in front of or behind the color filter 300, relative to the object to be photographed. That is, the color filter 300 may be disposed in front of or behind the main lens 310. The main lens 310 may be divided into regions matching the divided regions of the color filter 300. The divided regions of the main lens 310 allows light to pass therethough.

The infrared cut-off filter 320 blocks infrared rays. The infrared cut-off filter 320 may be disposed in front of or behind the main lens 310, or in front of the image sensor 340.

The optic unit 330 allows light passing through the color filter 300, the main lens 310 or the infrared cut-off filter 320 to travel with a changed angle. The optic unit 330 may be implemented using, for example, a micro-lens array including a plurality of microlenses, or a heterodyne mask, or the like.

The image sensor 340 recognizes light passing through the optic unit 330. In this case, the image sensor 340 may include a plurality of photosensors. A photosensor may be provided to each pixel, so the image sensor 340 may recognize incident light in units of pixels. Accordingly, the image sensor 340 captures an image based on the incident light in units of pixels.

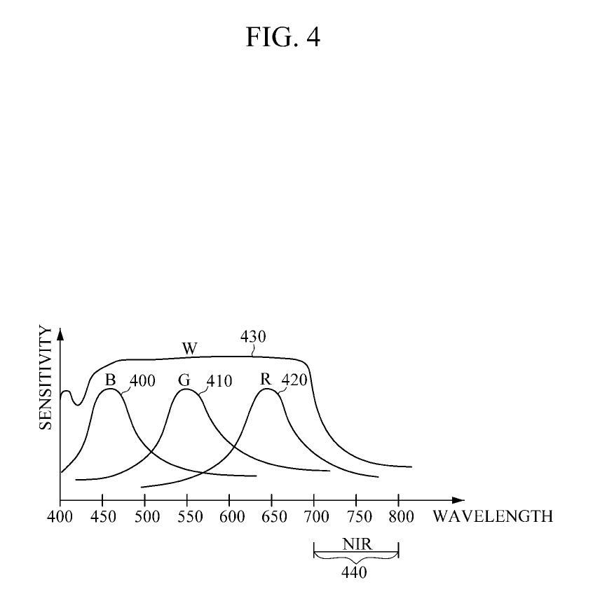

Hereinafter, the configuration of the color filter 300, the main lens 310, the infrared cut-off filter 320, the optic unit 330, and the image sensor 340 according to color patterns forming the color filter will be described in more detail. The types of colors will be described according to FIG. 4.

FIG. 4 is a graph illustrating a spectral sensitivity. A measuring unit of the light wavelength is nm, and a measuring unit of sensitivity may vary depending on a setting. The relative dimension of sensitivity is represented on the vertical axis.

As illustrated in FIG. 4, B (Blue) 400 has a maximum value at approximately 450 nm, G (Green) 410 has a maximum value at approximately 550 nm, and R (Red) 420 has the maximum value at approximately 650 nm. White (W) 430 has a wavelength range including R, G, and B. In FIG. 4, near infrared (NIR) rays have a wavelength range of about 700 nm to about 800 nm, but the wavelength range of NIR may be changeably defined. White and near infrared (WNIR) has a wavelength range including WHITE and NIR parts.

Hereinafter, example configurations of the imaging apparatus will be described in which the color filter is divided into color patterns such as RGBG, CYYM, and CMYK without using WHITE and NIR parts.

In one example, the imaging apparatus may be configured as follows. The color filter 300 is disposed in front of or behind the main lens 310, the optic unit 330 is disposed behind the color filter 300 and the main lens 310, and the image sensor 340 is disposed behind the optic unit 330.

In another example, the imaging apparatus may be configured as follows. The color filter 300 and the infrared cut off filter 320 are disposed in front of or behind the main lens 310, the optic unit 330 is disposed behind the color filter 300 and the main lens 310, and the image sensor 340 is disposed behind the optic unit 330.

That is, in examples in which the color filter is divided into color patterns without using WHITE and NIR, the infrared cut off filter 320 is selectively used.

Hereinafter, example configurations of the imaging apparatus will be described in which the color filter may be divided into color patterns using WHITE and NIR, such as RGBW and RGBWNIR.

In an example in which RGBW color patterns are used, the imaging apparatus may be configured as follows. The color filter 300 and the infrared cut off filter 320 are disposed in front of or behind the main lens 310, the optic unit 330 is disposed behind the color filter 300 and the main lens 310, and the image sensor 340 is disposed behind the optic unit 330. The infrared cut off filter 320 blocks light of a predetermined wavelength range other than WHITE.

In an example in which RGBWNIR color patterns are used, the imaging apparatus may be configured as follows. The color filter 300 and the infrared cut off filter 320 are disposed in front of or behind the main lens 310. The optic unit 330 is disposed behind the color filter 300 and the main lens 310. The image sensor 340 is disposed behind the optic unit 330. The infrared cut off filter 320 blocks a predetermined wavelength range other than NIR.

The color filter 300, the main lens 310, and the infrared cut off filter 320 may represent the optical apparatus in cooperation with each other. In this case, the infrared cut off filter 320 may be disposed in front of or behind the main lens 310.

The color filter 300, the main lens 310, and the infrared cut off filter 320 may be integrally formed with each other, thereby implementing an optical apparatus.

As described above, the imaging apparatus may be implemented in various associations of components according to setting.

FIGS. 5A and 5B illustrate examples of an optic unit.

FIG. 5A is a view used to describe an optic unit which is implemented using a microlens array.

As illustrated in FIG. 5A, the imaging apparatus includes a color filter 500a, a main lens 510a, an optic unit 520a, and an image sensor 530a. The optic unit 520a is implemented using a microlens array including a plurality of microlenses. Each microlens included in the microlens array serves to allow light passing through the main lens 510a to be incident to some pixels of the image sensor 530a. The microlenses are designed to correspond to the pixels of the image sensor 530a on a one-to-one basis. That is, the respective microlenses serve to allow light to be incident to different pixels.

If the position of the microlens array or the shape of the microlens is changed, the number of pixels used to recognize a single point is changed.

FIG. 5B is a view used to describe an optic unit that is implemented using a heterodyne mask.

As illustrated in FIG. 5B, the imaging apparatus includes a color filter 500b, a main lens 510b, an optic unit 520b, and an image sensor 530b. The optic unit 520b is implemented using a heterodyne mask. The heterodyne mask allows light passing through the main lens 510b to be incident to some pixels of the image sensor 530b. Respective regions of the heterodyne mask are designed to correspond to the pixels of the image sensor 530b on a one-to-one basis. That is, the respective regions of the heterodyne mask serve to allow light to be incident to different pixels.

The above examples have been described according to configurations in which the optical unit is implemented using a microlens array or a heterodyne mask, but the configuration of the optic unit is not limited thereto. According to another example, an optical unit may be implemented using any other device capable of changing the angle of transmission of light while the light passes through the optical unit.

FIGS. 6A and 6B illustrate the change in number of pixel regions used to recognize a single point.

FIG. 6A illustrates a change of the number of pixel regions used to recognize a single point with a change in the shape of the optic unit.

As illustrated in FIG. 6A, the imaging apparatus includes a color filter 600a, a main lens 610a, an optic unit 620a, and an image sensor 630a. The optic unit 620a is disposed at a focal distance of the main lens 610a. As the shape of the optic unit is changed, the area of the image sensor 630a onto which light is incident may be increased, and accordingly the number of pixel regions used to recognize a single point may be increased. For example, in a case in which the number of pixel regions used to recognize a single point is 4(2×2), if the optic unit 620a is changed into a predetermined shape to increase the area of the image sensor 630a onto which light is incident, the number of pixel regions 640a may be changed, for example, into 16(4×4).

FIG. 6B illustrates a change of the number of pixel regions used to recognize a single point with a change in the position of the optic unit.

As illustrated in FIG. 6B, the imaging apparatus includes a color filter 600b, a main lens 610b, an optic unit 620b, and an image sensor 630b. The optic unit 620b is provided at a position inside the focal distance of the main lens 610b, and this shortens the distance traveled by admitted light from the main lens 610b to the optic unit 620b. Accordingly, the area of the image sensor 630b receiving light may be increased compared to a case in which an optical unit is positioned at the focal distance of the main lens 610b, and the number of pixel regions used to recognize a single point is increased. For example, in an example configuration in which the number of pixel regions used to recognize a single point is 4(2×2), if the position of the optic unit 620b is changed so as to be provided at a point inside of the focal distance of the image sensor 630b to increase the area of the image sensor 630b receiving light, the number of pixel regions 640b may be changed to a larger number such as, for example, 16(4×4).

As described above, if the position or the shape of the optic unit is changed, the number of pixel regions used to recognize a single point is changed.

A number of examples have been described above. Nevertheless, it will be understood that various modifications may be made. For example, suitable results may be achieved if the components in the described configurations are combined in a different manner and/or replaced or supplemented by other components or their equivalents. Accordingly, other implementations are within the scope of the following claims.

What is claimed is:

1. An imaging apparatus comprising:
a color filter divided into a plurality of regions, each of the regions configured to allow light of a preset wavelength range to pass therethrough;
a main lens disposed at a front or a rear of the color filter to allow light to pass therethrough; and
an optic unit to allow the light passing through the color filter or the main lens to pass therethrough.

2. The imaging apparatus of claim 1, wherein the optic unit is configured to change an angle of transmission of the light passing through the optic unit.

3. The imaging apparatus of claim 1, further comprising:
an image sensor to receive the light;
wherein a number of the regions of the color filter is equal to or less than a number of pixels of the image sensor that are used to recognize a single point.

4. The imaging apparatus of claim 2, further comprising:
an image sensor to receive the light;
wherein the angle of transmission of the light passing through the optic unit and a number of pixels of the image sensor used to recognize a single point corresponds to a position and/or shape of the optic unit.

5. The imaging apparatus of claim 1, wherein the main lens is divided into regions corresponding to the regions of the color filter.

6. The imaging apparatus of claim 1, wherein the optic unit is formed using a micro-lens array and/or a heterodyne mask.

7. The imaging apparatus of claim 1, further comprising an infrared ray cut off filter configured to block infrared rays.

8. The imaging apparatus of claim 1, further comprising an image sensor to recognize light passing through the optic unit.

9. An optical apparatus comprising:
a color filter divided into a plurality of regions, each of the regions configured to allow light of a preset wavelength range to pass therethrough; and
a main lens disposed at a front or a rear of the color filter to allow light to pass light therethrough.

10. The optical apparatus of claim 9, wherein the main lens is divided into regions corresponding to the regions of the color filter.

11. The optical apparatus of claim 9, further comprising an infrared ray cut off filter which is disposed at a front or a rear of the main lens to block infrared rays.

12. An imaging apparatus comprising:
a color filter having a plurality of regions;
wherein at least two of the regions transmit light of different wavelengths; and
a number of the regions is equal to or less than a number of pixels of an image sensor receiving the light.

13. The imaging apparatus of claim 12, further comprising a main lens provided at a front or rear of the color filter.

14. The imaging apparatus of claim 13, wherein the color filter is integrated with the main lens.

15. The imaging apparatus of claim 13, wherein the color filter is formed on the main lens with a color resin.

16. The imaging apparatus of claim 13, wherein the color filter is a dichroic filter.

17. The imaging apparatus of claim 13, wherein the main lens has a plurality of regions corresponding to the regions of the color filter.

18. The imaging apparatus of claim 12, further comprising:
an optic unit to change an angle of transmission of the light; and
the image sensor to receive the light from the optic unit.

19. The imaging apparatus of claim 18, wherein a number of pixels of the image sensor used to recognize a portion of an object corresponds to a position and/or shape of the optic unit.

20. The imaging apparatus of claim 12, further comprising an infrared ray cut off filter to block infrared rays.
